(19) United States
(12) Patent Application Publication
(10) Pub. No.: US 2016/0253239 A1
(43) Pub. Date: Sep. 1, 2016

(54) DATA STORAGE DEVICE AND OPERATING METHOD THEREOF

(71) Applicant: SK hynix Inc., Gyeonggi-do (KR)

(72) Inventor: Gi Pyo UM, Gyeonggi-do (KR)

(21) Appl. No.: 14/790,787

(22) Filed: Jul. 2, 2015

(30) Foreign Application Priority Data
Feb. 27, 2015 (KR) 10-2015-0028334

(51) Int. Cl. G06F 11/10; G06F 3/06

(52) U.S. Cl. CPC G06F 11/1076; G06F 3/0619; G06F 3/064; G06F 3/0673

(57) ABSTRACT

An operating method of a data storage device includes encoding write data using an error correction code (ECC), inserting an error in encoded data, and storing error-inserted data.

### CROSS-REFERENCES TO RELATED APPLICATION

The present application claims priority under 35 U.S.C. §119(a) to Korean application number 10-2015-0028334, filed on Feb. 27, 2015, in the Korean Intellectual Property Office, which is incorporated herein by reference in its entirety.

### BACKGROUND

1. Technical Field

Various embodiments generally relate to a data storage device and, more particularly, to a data storage device capable of performing a data processing operation for improving the reliability of data and an operating method thereof.

2. Related Art

The paradigm for the computing environment has shifted to ubiquitous computing so that computer systems can be used anytime and anywhere. The use of portable electronic devices such as mobile phones, digital cameras, and notebook computers has rapidly increased. In general, such portable electronic devices use a data storage device, which uses a memory device. The data storage device is used as a main memory device or an auxiliary memory device of the portable electronic devices.

A data storage device using a memory device may provide excellent stability and durability and operate with high information access speed and low power consumption, since it has no moving parts. Data storage devices having such advantages include universal serial bus (USB) memory devices, memory cards having various interfaces, universal flash storage (UFS) devices, and solid state drives (SSD).

Memory devices have memory cells for storing data. The data stored in the memory cells may be unintentionally influenced, then sensed as different values than originally inputted, due to interference between the memory cells. For example, the data stored in the memory cells may be altered by disturbance or coupling between the memory cells. For another example, the data stored in the memory cells may change due to the wear of the memory cells caused by repetitive erase/program operations. When the data stored in memory cells are sensed as different values or are changed by various causes, the data stored in the memory cells may have errors.

When specific data patterns are stored in memory cells, interference, disturbance and coupling may increase, resulting in an increase in the amount of errors. In order to decrease the error rate of the data stored in memory cells, a data storage device may perform a randomization operation before storing the data. Further, the data storage device may perform a derandomization operation after the data is read from the memory cells.

### SUMMARY

Various embodiments are directed to a data storage device capable of performing a data processing operation for improving the reliability of storing data and an operating method thereof.

In an embodiment, an operating method of a data storage device may include encoding write data using an error correction code (ECC), inserting an error in encoded data, and storing error-inserted data.

In an embodiment, a data storage device may include an error correction code (ECC) unit suitable for processing write data using an ECC, an error insertion unit suitable for inserting an error in processed data, a randomization unit suitable for randomizing error-inserted data, and a control unit suitable for storing randomized data in a nonvolatile memory device.

In an embodiment, an operating method of a data storage device may include encoding write data and decoding read data using an error correction code (ECC), inserting an error in encoded data, and storing error-inserted data and reading stored data as the read data.

According to the embodiments, the reliability of a data storage device may be improved.

### BRIEF DESCRIPTION OF THE DRAWINGS

FIG. 1 is a block diagram illustrating a data storage device in accordance with an embodiment.

FIG. 2 is a block diagram illustrating a data storage device in accordance with another embodiment.

FIG. 3 is a flow chart to assist in the explanation of the write operation of the data storage device in accordance with the embodiment.

FIG. 4 is a diagram to assist in the explanation of a changing process of a write data processed according to the flow chart of FIG. 3.

FIGS. 5 to 7 are diagrams to assist in the explanation of the error insertion step of FIG. 3.

FIG. 8 is a flow chart to assist in the explanation of the read operation of the data storage device in accordance with the embodiment.

FIG. 9 is a diagram to assist in the explanation of a changing process of read data processed according to the flow chart of FIG. 8.

FIG. 10 is a block diagram illustrating a data processing system including a data storage device in accordance with an embodiment.

FIG. 11 is a block diagram illustrating a data processing system including a solid state drive (SSD) in accordance with an embodiment.

FIG. 12 is a block diagram illustrating an SSD controller shown in FIG. 11.

FIG. 13 is a block diagram illustrating a computer system in which a data storage device is mounted, in accordance with an embodiment.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings, the drawings are not necessarily to scale, and proportions may be exaggerated to more clearly depict certain features of the invention. While particular terminology is used, it is to be appreciated that the terminology is for describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, does not preclude the presence or addition of one or more other features, steps, operations, and/or elements thereof.

Hereinafter, a data storage device and an operating method thereof will be described with reference to the accompanying drawings through various embodiments.

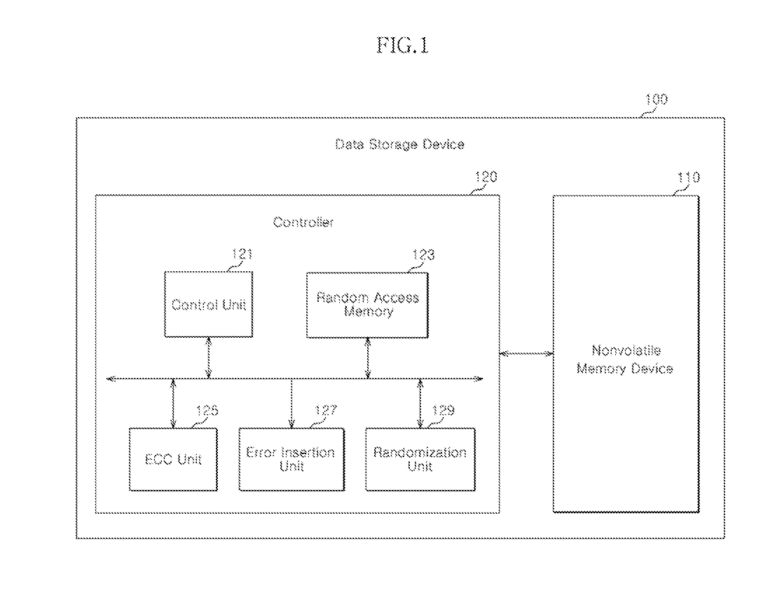

FIG. 1 is a block diagram illustrating a data storage device in accordance with an embodiment. A data storage device 100 may store data to be accessed by a host device (not shown) such as a mobile phone, an MP3 player, a laptop computer, a desktop computer, a game player, a TV, an in-vehicle infotainment system, and so forth. The data storage device 100 may also be referred to as a memory system.

The data storage device 100 may be manufactured as any one of various kinds of storage devices depending on the protocol of an interface which electrically couples the data storage device 100 with the host device. For example, the data storage device 100 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a personal computer memory card international association (PCMCIA) card, a peripheral component interconnection (PCI) card, a PCI express (PCI-E) card, a compact flash (CF) card, a smart media card, a memory stick, and so forth.

The data storage device 100 may be manufactured as any one of various package types. For example, the data storage device 100 may be manufactured as any one of various package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The data storage device 100 may include a nonvolatile memory device 110. The nonvolatile memory device 110 may operate as the storage medium of the data storage device 100. The nonvolatile memory device 110 may be configured by any one of various types of nonvolatile memory devices such as a NAND flash memory device, a NOR flash memory device, a ferroelectric random access memory (FRAM) using a ferroelectric capacitor, a magnetoresistive random access memory (MRAM) using a tunneling magnetoresistance (TMR) layer, a phase change random access memory (PRAM) using a chalcogenide alloy, and a resistive random access memory (ReRAM) using a transition metal oxide, depending on memory cells which construct a memory cell region.

The data storage device 100 may include a controller 120. The controller 120 may include a control unit 121, a random access memory 123, an error correction code (ECC) unit 125, an error insertion unit 127, and a randomization unit 129.

The control unit 121 may control the general operations of the controller 120. The control unit 121 may analyze and process a signal, a command or a request which is inputted from the host device. To this end, the control unit 121 may decode and drive the firmware or software loaded on the random access memory 123. The control unit 121 may be realized in the form of hardware or in the combined form of hardware and software.

The random access memory 123 may store firmware or software to be driven by the control unit 121. Also, the random access memory 123 may store data necessary for the driving of the firmware or the software, for example, metadata such as address mapping information. That is to say, the random access memory 123 may operate as the working memory of the control unit 121.

The random access memory 123 may temporarily store data to be transmitted from the host device to the nonvolatile memory device 110 or from the nonvolatile memory device 110 to the host device. In other words, the random access memory 123 may operate as a data buffer memory or a data cache memory.

The ECC unit 125 may ECC-process data to be stored in the nonvolatile memory device 110. During a write operation for writing data in the nonvolatile memory device 110, ECC-processing may include an ECC encoding operation, that is, an operation of generating an error correction code and an operation of adding the generated error correction code. For example, the ECC unit 125 may generate an error correction code for the data to be stored in the nonvolatile memory device 110. Further, the ECC unit 125 may add the generated error correction code to the data to be stored in the nonvolatile memory device 110.

The ECC unit 225 may ECC-process data read from the nonvolatile memory device 210 as well. During a read operation for reading the data stored in the nonvolatile memory device 110, ECC-processing may include an ECC decoding operation, that is, an error detection operation and an error correction operation based on the error correction code. For example, the ECC unit 125 may inspect whether an error is included in the data read from the nonvolatile memory device 110. The ECC unit 125 may remove or correct the error included in the data, within the range of error correction capability.

When the data stored in the memory cells of the nonvolatile memory device 110 are changed and read as different values from the original values, it may mean that an error has occurred in the data. The error insertion unit 127 may artificially and randomly insert an error in the data to be stored in the nonvolatile memory device 110. Namely, the error insertion unit 127 may change the data to be stored in the nonvolatile memory device 110 into data different from the original data, by inserting the error. The error insertion unit 127 may be realized in the form of software, hardware or a combination of software and hardware.

The randomization unit 129 may randomize the data to be stored in the nonvolatile memory device 110. Also, the randomization unit 129 may derandomize the data read from the nonvolatile memory device 110. The randomization unit 129 may randomize or derandomize the data by calculating the logic of the data and seed values. The randomization unit 129 may be realized in the form of software, hardware or a combination of software and hardware.

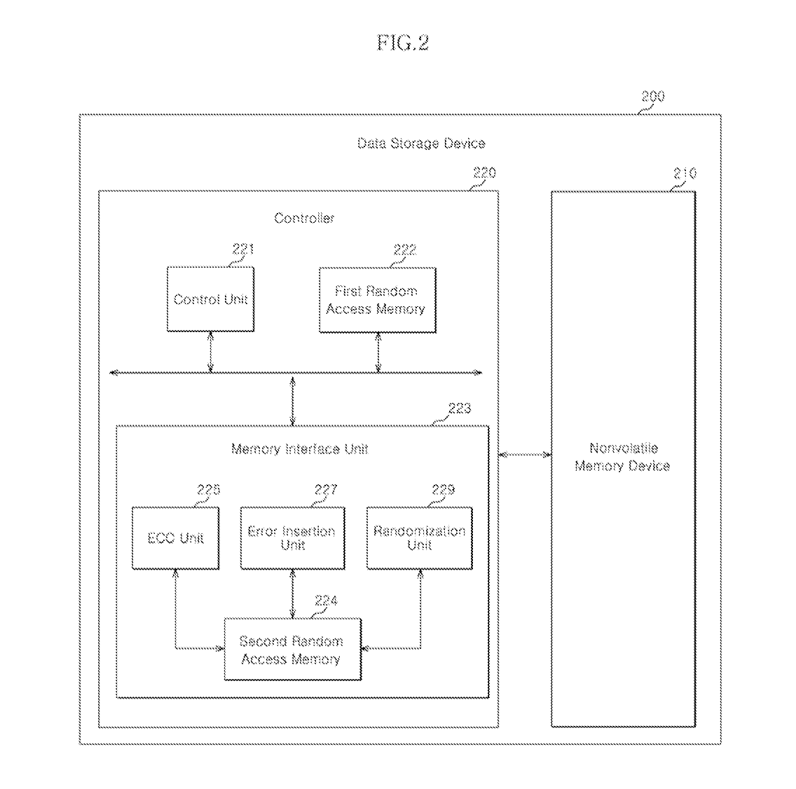

FIG. 2 is a block diagram illustrating a data storage device in accordance with another embodiment.

The data storage device 200 may include a nonvolatile memory device 210. The nonvolatile memory device 210 may operate as the storage medium of the data storage device 200.

The data storage device 200 may include a controller 220. The controller 220 may include a control unit 221, a first random access memory 222, and a memory interface unit 223.

The control unit 221 may control the general operations of the controller 220. The control unit 221 may analyze and process a signal, a command or a request which is inputted from a host device. To this end, the control unit 221 may decode and drive the firmware or software loaded on the first random access memory 222. The control unit 221 may be realized in the form of hardware or in the combined form of hardware and software.

The first random access memory 222 may store firmware or software to be driven by the control unit 221. Also, the first random access memory 222 may store data necessary for the driving of the firmware or the software, for example, metadata such as address mapping information. That is to say, the first random access memory 222 may operate as the working memory of the control unit 221.

The memory interface unit 223 may provide control signals (for example, a command, an address and an operation control signal) to the nonvolatile memory device 210 under the control of the control unit 221. Further, the memory interface unit 223 may exchange data with the nonvolatile memory device 210. The memory interface unit 223 may include a second random access memory 224, an error correction code (ECC) unit 225, an error insertion unit 227, and a randomization unit 229.

The second random access memory 224 may temporarily store data to be transmitted from the host device to the nonvolatile memory device 210 or from the nonvolatile memory device 210 to the host device. In other words, the second random access memory 224 may operate as a data buffer memory or a data cache memory.

The ECC unit 225 may ECC-process data to be stored in the nonvolatile memory device 210. During a write operation for writing data in the nonvolatile memory device 210, ECC-processing may include an ECC encoding operation, that is, an operation of generating an error correction code and an operation of adding the generated error correction code. For example, the ECC unit 225 may generate an error correction code for the data to be stored in the nonvolatile memory device 210. Further, the ECC unit 225 may add the generated error correction code to the data to be stored in the nonvolatile memory device 210.

The ECC unit 225 may ECC-process data to be stored in the nonvolatile memory device 210 as well. During a read operation for reading the data stored in the nonvolatile memory device 210, ECC processing may include an ECC decoding operation, that is, an error detection operation and an error correction operation based on the error correction code. For example, the ECC unit 225 may inspect whether an error was included in the data read from the nonvolatile memory device 210. The ECC unit 225 may remove or correct the error included in the data, within the range of error correction capability.

The error insertion unit 227 may artificially and randomly insert an error in the data to be stored in the nonvolatile memory device 210. Namely, the error insertion unit 227 may change the data to be stored in the nonvolatile memory device 210 into data different from the original data, by inserting the error.

The randomization unit 229 may randomize the data to be stored in the nonvolatile memory device 210. Also, the randomization unit 229 may derandomize the data read from the nonvolatile memory device 210. The randomization unit 229 may randomize or derandomize the data by calculating the logic of the data and seed values.

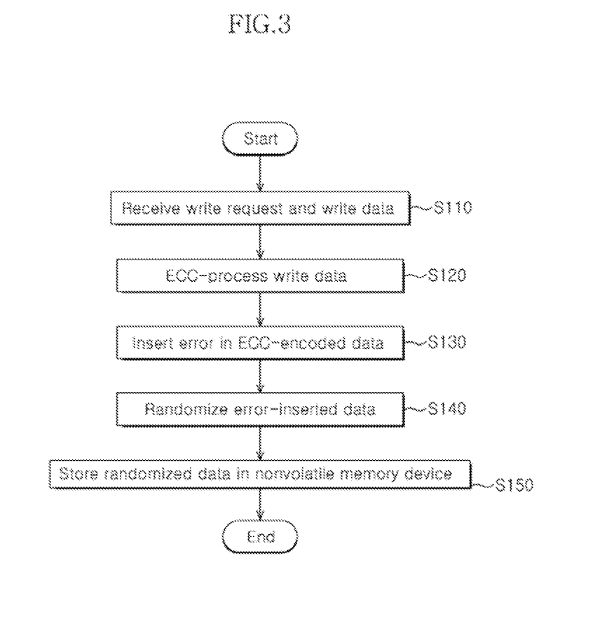

FIG. 3 is a flow chart to assist in the explanation of the write operation of the data storage device in accordance with the embodiment. For example, the flow chart of the write operation shown in FIG. 3 will be described with reference to the components of the data storage device 100 shown in FIG. 1, that is, the control unit 121, the random access memory 123, the ECC unit 125, the error insertion unit 127 and the randomization unit 129. It is to be readily understood that descriptions may be made by replacing the control unit 121, the random access memory 123, the ECC unit 125, the error insertion unit 127 and the randomization unit 129 with the components of the data storage device 200 shown in FIG. 2, that is, the control unit 221, the second random access memory 224, the ECC unit 225, the error insertion unit 227 and the randomization unit 229, respectively.

At step S110, the control unit 121 may receive a write request and write data from the host device. The control unit 121 may store the write data in the random access memory 123.

At step S120, the ECC unit 125 may ECC-process the write data. That is to say, the ECC unit 125 may perform the ECC encoding of generating an error correction code for the write data and adding the generated error correction code to the write data.

At step S130, the error insertion unit 127 may insert an error in the ECC-processed data, that is, the ECC-encoded data. The error insertion step performed by the error insertion unit 127 will be described later in detail.

At step S140, the randomization unit 129 may randomize the error-inserted data. In other words, the randomization unit 129 may generate randomized data by calculating the logic of the error-inserted data and a seed value.

At step S150, the control unit 121 may store the randomized data stored in the random access memory 123, in the nonvolatile memory device 110.

When considering performance and reliability, which are in a trade-off relationship, the step S140 may be omitted. When step S140 is omitted, in step S150, the control unit 121 may store the error-inserted data in the nonvolatile memory device 110.

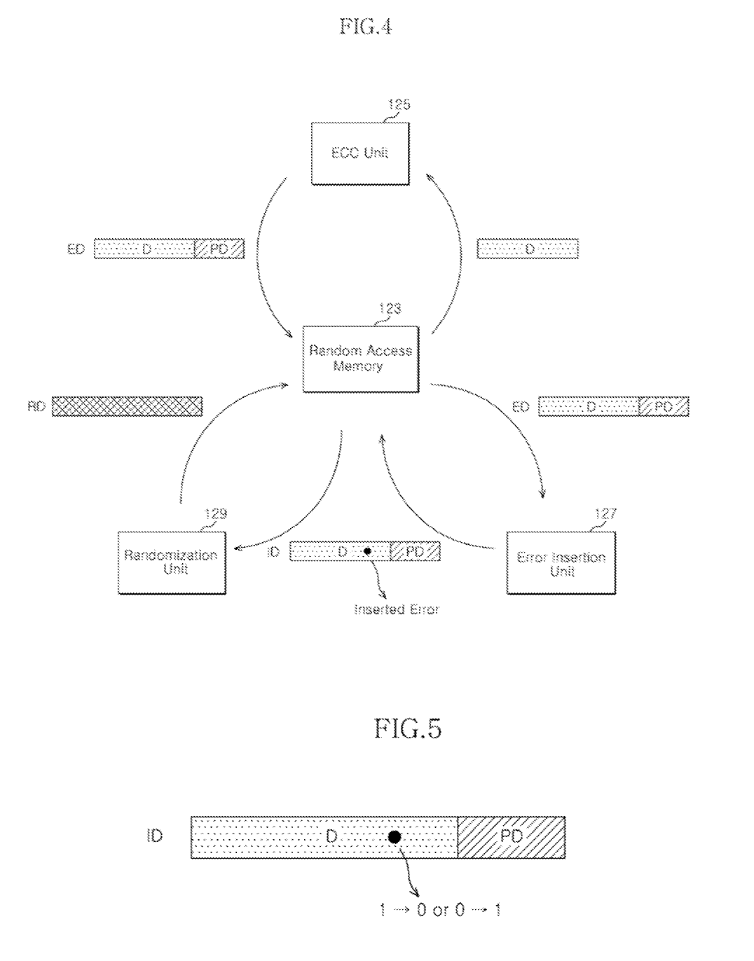

FIG. 4 is a diagram to assist in the explanation of a changing process of the write data processed according to the flow chart of FIG. 3. For example, the changing process of the write data shown in FIG. 4 will be described with reference to the components of the data storage device 100 shown in FIG. 1, that is, the random access memory 123, the ECC unit 125, the error insertion unit 127 and the randomization unit 129. It is to be readily understood that descriptions may be made by replacing the random access memory 123, the ECC unit 125, the error insertion unit 127 and the randomization unit 129 with the components of the data storage device 200 shown in FIG. 2, that is, the second random access memory 224, the ECC unit 225, the error insertion unit 227 and the randomization unit 229, respectively.

Write data D stored in the random access memory 123 may be inputted to the ECC unit 125. If the write data D is ECC-processed by the ECC unit 125, the write data D may be changed into ECC-encoded data ED added with an error correction code, that is, parity data PD. The ECC-encoded data ED may be stored in the random access memory 123.

The ECC-encoded data ED stored in the random access memory 123 may be inputted to the error insertion unit 127. If an error (see the symbol •) is inserted at a random position of the ECC-encoded data ED by the error insertion unit 127, the ECC-encoded data ED may be changed into error-inserted data ID. The error-inserted data ID may be stored in the random access memory 123.

The error-inserted data ID may be input to the randomization unit 129. If the error-inserted data ID is randomized by the randomization unit 129, the error-inserted data ID may be changed into randomized data RD. The randomized data RD may be stored in the random access memory 123.

The ECC unit 125 may output the same output data each time the same input data is inputted. When a seed value is the same, the randomization unit 129 may also output the same output data each time the same input data is inputted. However, because the error insertion unit 127 randomly inserts an error, different output data may be outputted each time even though the same input data is inputted.

Namely, even though the same write data D is write-requested, the randomized data RD to be stored in the nonvolatile memory device 110 may become different each time, by a series of data processing processes for improving the reliability of data, in particular, a processing operation by the error insertion unit 127. That is, the error insertion unit 127 may prevent the same write data D from being fixed to randomized data RD of a specific pattern. When the same write data D is not fixed to randomized data RD of a specific pattern, the influence exerted on memory cells by interference, disturbance or coupling is reduced, and thus, the data error rate may decrease.

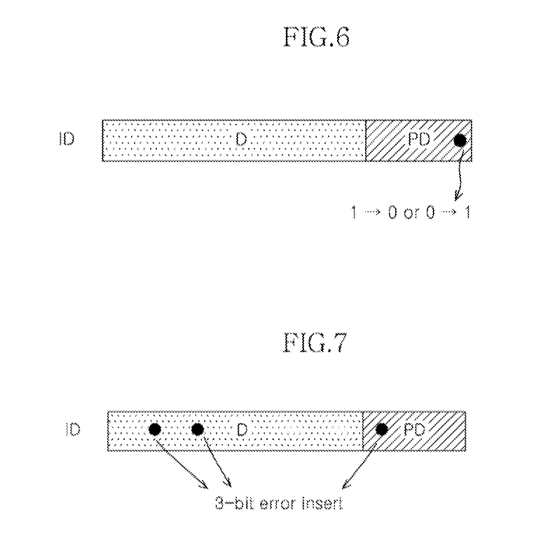

FIGS. 5 to 7 are diagrams to assist in the explanation of the error insertion step of FIG. 3. The error insertion step may be performed by inverting at least one bit at a random position among the data bits of input data.

That is to say, the error insertion unit 127 may change at least one bit value among bit values of input data, into another value. Further, the error insertion unit 127 may change the bit value at a random position into another value. Referring to FIGS. 4 and 5, the error insertion unit 127 may change the bit value positioned at a data portion D of ECC-encoded data ED. The bit value may change from 1/0 into 0/1, respectively. Referring to FIGS. 4 and 6, the error insertion unit 127 may change the bit value positioned at a parity data portion PD of the ECC-encoded data ED. The bit value may change from 1/0 into 0/1, respectively.

The error insertion unit 127 may change the bit value of input data into another value within the range of error correction capability of the ECC unit 125 such that the number of error bits of the input data may not exceed the number of bits correctable by the ECC unit. Referring to FIG. 7, when the error correction capability of the ECC unit 125 is 3 bits, the error insertion unit 127 may change three bit values into other values.

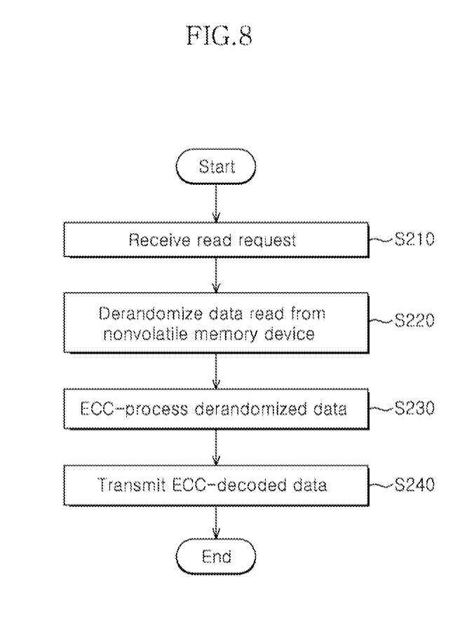

FIG. 8 is a flow chart to assist in the explanation of the read operation of the data storage device in accordance with the embodiment. For example, the flow chart of the read operation shown in FIG. 8 will be described with reference to the components of the data storage device 100 shown in FIG. 1, that is, the control unit 121, the random access memory 123, the ECC unit 125 and the randomization unit 129. It is to be readily understood that descriptions may be made by replacing the control unit 121, the random access memory 123, the ECC unit 125 and the randomization unit 129 with the components of the data storage device 200 shown in FIG. 2, that is, the control unit 221, the second random access memory 224, the ECC unit 225 and the randomization unit 229, respectively.

At step S210, the control unit 121 may receive a read request from the host device. The control unit 121 may read data from the nonvolatile memory device 110, and store read data in the random access memory 123.

At step S220, the randomization unit 129 may derandomize the read data. In other words, the randomization unit 129 may generate derandomized data by calculating the logic of the read data and a seed value. For instance, the seed value used in the derandomization operation of the step S220 may be the same as the seed value used in the randomization operation of the step S140.

At step S230, the ECC unit 125 may ECC-process the derandomized data. Namely, the ECC-unit 125 may perform ECC decoding of inspecting whether an error is included in the derandomized data, based on the error correction code included in the derandomized data, and removing or correcting the error included in the derandomized data within the range of error correction capability.

At step S240, the control unit 121 may transmit ECC-decoded data to the host device. That is to say, the control unit 121 may transmit original data recovered to the write-requested state by ECC processing, to the host device.

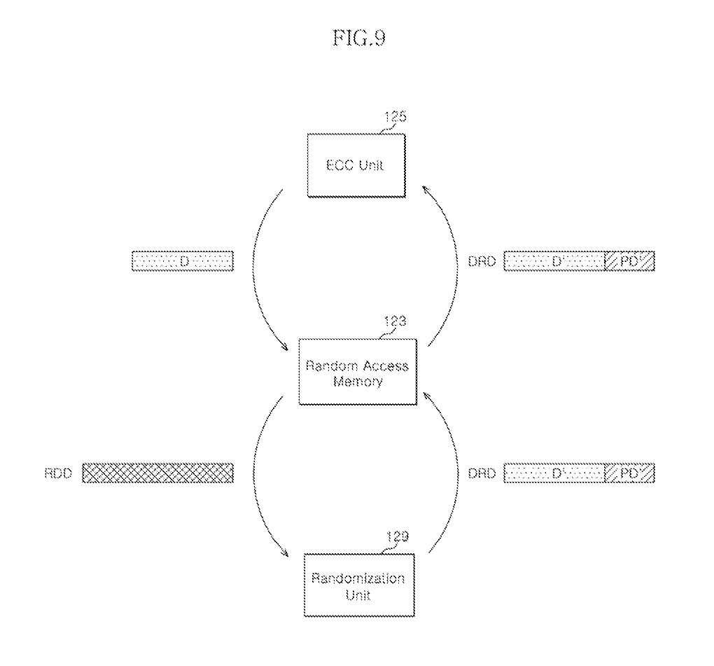

FIG. 9 is a diagram to assist in the explanation of a changing process of the read data processed according to the flow chart of FIG. 8. For example, the changing process of the read data shown in FIG. 9 will be described with reference to the components of the data storage device 100 shown in FIG. 1, that is, the random access memory 123, the ECC unit 125 and the randomization unit 129. It is to be readily understood that descriptions may be made by replacing the random access memory 123, the ECC unit 125 and the randomization unit 129 with the components of the data storage device 200 shown in FIG. 2, that is, the second random access memory 224, the ECC unit 225 and the randomization unit 229, respectively.

Read data RDD stored in the random access memory 123 may be inputted to the randomization unit 129. If the read data RDD is derandomized by the randomization unit 129, the read data RDD may be changed into derandomized data DRD. The derandomized data DRD may be constructed by data D′ and parity data PD′ that includes an error artificially inserted in the write operation. The derandomized data DRD may be stored in the random access memory 123.

The derandomized data DRD stored in the random access memory 123 may be inputted to the ECC unit 125. If the derandomized data DRD is ECC-processed by the ECC unit 125, the derandomized data DRD may be changed into data D from which the error correction code, that is, the parity data PD′ are removed.

Through such a series of processes, the read data RDD may be changed into data recovered to the write-requested state, that is, write data D.

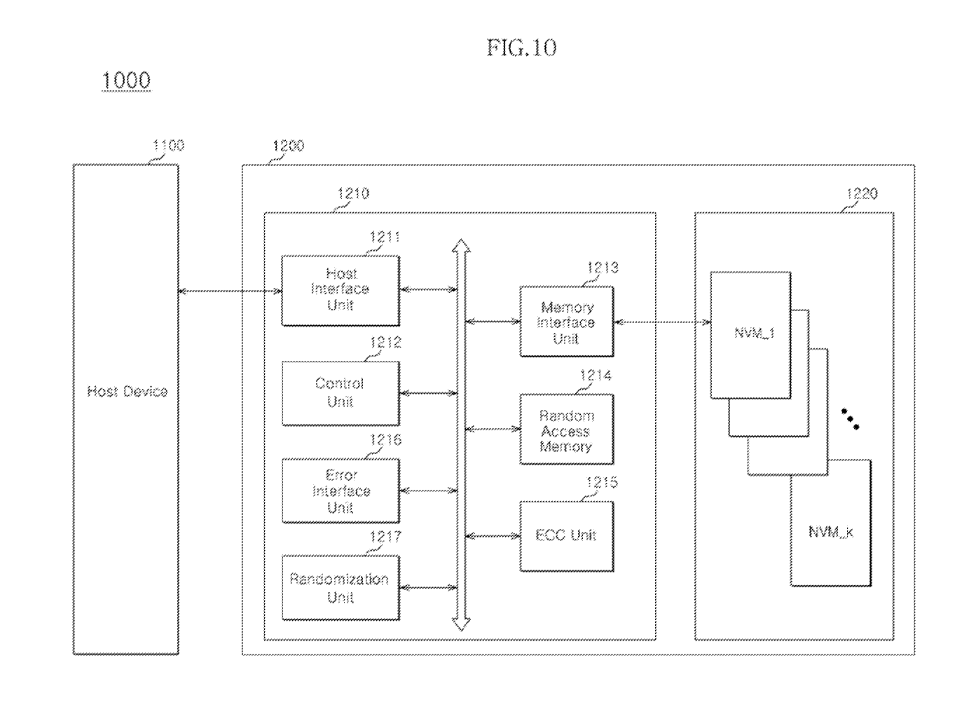

FIG. 10 is a block diagram illustrating a data processing system including a data storage device in accordance with an embodiment. Referring to FIG. 10, a data processing system 1000 may include a host device 1100 and a data storage device 1200.

The data storage device 1200 may include a controller 1210 and a nonvolatile memory device 1220. The data storage device 1200 may be used by being coupled to the host device 1100 such as a mobile phone, an MP3 player, a laptop computer, a desktop computer, a game player, a TV, an in-vehicle infotainment system, and so forth. The data storage device 1200 is also referred to as a memory system.

The controller 1210 may include a host interface unit 1211, a control unit 1212, a memory interface unit 1213, a random access memory 1214, an error correction code (ECC) unit 1215, an error insertion unit 1216, and a randomization unit 1217.

The control unit 1212 may control the general operations of the controller 1210 in response to a request from the host device 1100. The control unit 1212 may drive firmware or software for controlling the nonvolatile memory device 1220.

The random access memory 1214 may be used as the working memory of the control unit 1212. The random access memory 1214 may be used as a buffer memory which temporarily stores the data read from the nonvolatile memory device 1220 or the data provided from the host device 1100.

The host interface unit 1211 may interface the host device 1100 and the controller 1210. For example, the host interface unit 1211 may communicate with the host device 1100 through one of various interface protocols such as a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The memory interface unit 1213 may interface the controller 1210 and the nonvolatile memory device 1220. The memory interface unit 1213 may provide commands and addresses to the nonvolatile memory device 1220. Furthermore, the memory interface unit 1213 may exchange data with the nonvolatile memory device 1220.

The ECC unit 1215 may ECC-encode data to be stored in the nonvolatile memory device 1220. Also, the ECC unit 1215 may ECC-decode the data derandomized by the randomization unit 1217.

The error insertion unit 1216 may artificially insert an error in the data ECC-encoded by the ECC unit 1215.

The randomization unit 1217 may randomize the data in which the error is inserted by the error insertion unit 1216, by using a seed value. Moreover, the randomization unit 1217 may derandomize the data read from the nonvolatile memory device 1220, by using the seed value.

The error insertion unit 1216 and the randomization unit 1217 may be included in the memory interface unit 1213.

The nonvolatile memory device 1220 may be used as the storage medium of the data storage device 1200. The nonvolatile memory device 1220 may include a plurality of nonvolatile memory chips (or dies) NVM_1 to NVM_k.

The controller 1210 and the nonvolatile memory device 1220 may be manufactured as any one of various data storage devices. For example, the controller 1210 and the nonvolatile memory device 1220 may be integrated into one semiconductor device and may be manufactured as any one of a multimedia card in the form of an MMC, an eMMC, an RS-MMC and a micro-MMC, a secure digital card in the form of an SD, a mini-SD and an micro-SD, a universal serial bus (USB) storage device, a universal flash storage (UFS) device, a personal computer memory card international association (PCMCIA) card, a compact flash (CF) card, a smart media card, a memory stick, and so forth.

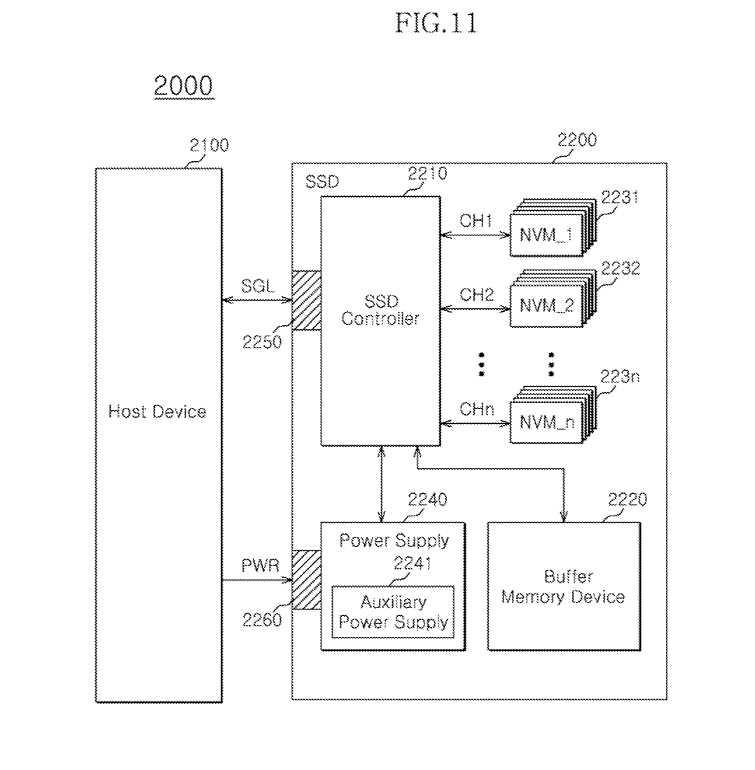

FIG. 11 is a block diagram illustrating a data processing system including a solid state drive (SSD) in accordance with an embodiment. Referring to FIG. 11, a data processing system 2000 may include a host device 2100 and a solid state drive (SSD) 2200.

The SSD 2200 may include an SSD controller 2210, a buffer memory device 2220, nonvolatile memory devices 2231 to 223n, a power supply 2240, a signal connector 2250, and a power connector 2260.

The SSD controller 2210 may access the nonvolatile memory devices 2231 to 223n in response to a request from the host device 2100.

The buffer memory device 2220 may temporarily store data which are to be stored in the nonvolatile memory devices 2231 to 223n. Further, the buffer memory device 2220 may temporarily store data which are read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may provide power PWR inputted through the power connector 2260, to the inside of the SSD 2200. The power supply 2240 may include an auxiliary power supply 2241. The auxiliary power supply 2241 may supply power to allow the SSD 2200 to properly terminate operations when a sudden power-off occurs. The auxiliary power supply 2241 may include super capacitors capable of being charged with the power PWR.

The SSD controller 2210 may exchange a signal SGL with the host device 2100 through the signal connector 2250. The signal SGL may include a command, an address, data, and so forth. The signal connector 2250 may be configured for various protocols such as parallel advanced technology attachment (PATA), serial advanced technology attachment (SATA), small computer system interface (SCSI), serial attached SCSI (SAS), peripheral component interconnection (PCI) and PCI express (PCI-E) protocols, depending on the interface scheme between the host device 2100 and the SSD 2200.

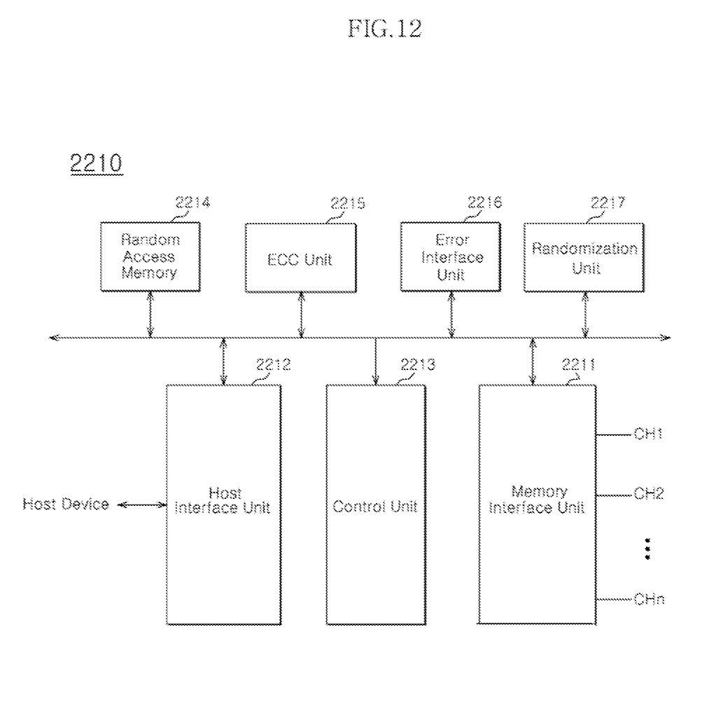

FIG. 12 is a block diagram illustrating the SSD controller shown in FIG. 11. Referring to FIG. 12, the SSD controller 2210 may include a memory interface unit 2211, a host interface unit 2212, a control unit 2213, a random access memory 2214, an error correction code (ECC) unit 2215, an error insertion unit 2216, and a randomization unit 2217.

The memory interface unit 2211 may provide a control signal such as a command and an address to the nonvolatile memory devices 2231 to 223n. Moreover, the memory interface unit 2211 may exchange data with the nonvolatile memory devices 2231 to 223n. The memory interface unit 2211 may scatter the data transmitted from the buffer memory device 2220 to the channels CH1 to CHn, under the control of the control unit 2213. Furthermore, the memory interface unit 2211 may transmit the data read from the nonvolatile memory devices 2231 to 223n to the buffer memory device 2220, under the control of the control unit 2213.

The host interface unit 2212 may provide interfacing with the SSD 2200 in correspondence to the protocol of the host device 2100. For example, the host interface unit 2212 may communicate with the host device 2100 through one of parallel advanced technology attachment (PATA), serial advanced technology attachment (SATA), small computer system interface (SCSI), serial attached SCSI (SAS), peripheral component interconnection (PCI) and PCI express (PCI-E) protocols. In addition, the host interface unit 2212 may perform a disk emulation function of supporting the host device 2100 to recognize the SSD 2200 as a hard disk drive (HDD).

The control unit 2213 may analyze and process the signal SGL inputted from the host device 2100. The control unit 2213 may control the operations of the buffer memory device 2220 and the nonvolatile memory devices 2231 to 223n based on firmware or software for driving the SSD 2200. The random access memory 2214 may be used as a working memory for driving the firmware or the software.

The ECC unit 2215 may generate the parity data of data to be transmitted to the nonvolatile memory devices 2231 to 223n among the data stored in the buffer memory device 2220. The generated parity data may be stored along with the transmitted data in the nonvolatile memory devices 2231 to 223n. The ECC unit 2215 may detect an error of the data derandomized by the randomization unit 2217. When the detected error is within a correctable range, the ECC unit 2215 may correct the detected error.

The error insertion unit 2216 may artificially insert an error in the data ECC-encoded by the ECC unit 2215.

The randomization unit 2217 may randomize the data in which the error is inserted by the error insertion unit 2216, by using a seed value. Moreover, the randomization unit 2217 may derandomize the data read from the nonvolatile memory devices 2231 to 223n among the data stored in the buffer memory device 2220, by using the seed value.

The error insertion unit 2216 and the randomization unit 2217 may be included in the memory interface unit 2211.

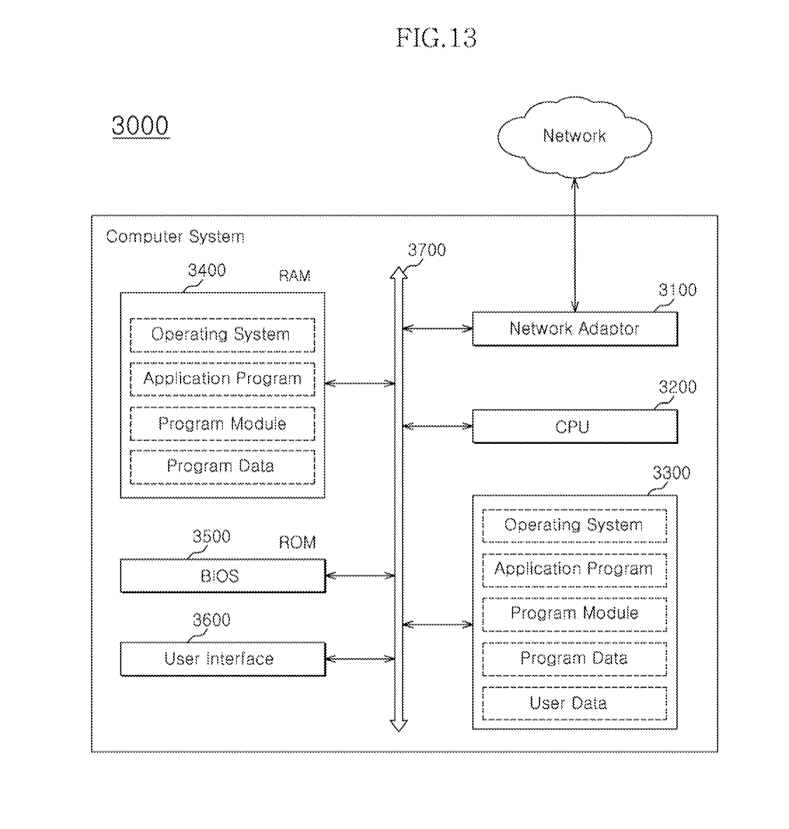

FIG. 13 is a block diagram illustrating a computer system in which a data storage device is mounted, in accordance with an embodiment. Referring to FIG. 13, a computer system 3000 includes a network adaptor 3100, a central processing unit 3200, a data storage device 3300, a RAM 3400, a ROM 3500 and a user interface 3600, which are electrically coupled to a system bus 3700. The data storage device 3300 may be constructed by the data storage device 100 shown in FIG. 1, the data storage device 200 shown in FIG. 2, the data storage device 1200 shown in FIG. 10 or the SSD 2200 shown in FIG. 11.

The network adaptor 3100 may provide interfacing between the computer system 3000 and external networks. The central processing unit 3200 performs general operations for driving an operating system or an application program loaded on the RAM 3400.

The data storage device 3300 may store general data necessary for the computer system 3000. For example, an operating system for driving the computer system 3000, an application program, various program modules, program data and user data may be stored in the data storage device 3300.

The RAM 3400 may be used as the working memory of the computer system 3000. Upon booting, the operating system, the application program, the various program modules and the program data necessary to drive programs, which are read from the data storage device 3300, may be loaded on the RAM 3400. A BIOS (basic input/output system) which is activated before the operating system is driven may be stored in the ROM 3500. Information exchange between the computer system 3000 and a user may be implemented through the user interface 3600.

While various embodiments have been described above, it will be understood to those skilled in the art that the embodiments described are examples only. Accordingly, the data storage device and the operating method thereof described herein should not be limited based on the described embodiments.

What is claimed is:

1. An operating method of a data storage device, comprising:
encoding write data using an error correction code (ECC);
inserting an error in encoded data; and
storing error-inserted data.

2. The operating method according to claim 1, wherein the inserting of the error comprises:
inverting one or more data bits of the encoded data.

3. The operating method according to claim 2, wherein a number of inverted bits is less than a number of bits correctable in decoding the encoded data.

4. The operating method according to claim 1,
wherein the encoded data includes the write data and parity data with respect to the write data, and
wherein the inserting of the error comprises:
inverting a data bit at a random position among data bits of the write data and the parity data.

5. The operating method according to claim 1, further comprising:
randomizing the error-inserted data, before the storing of the error-inserted data.

6. The operating method according to claim 5, further comprising:
derandomizing read data; and
decoding derandomized data using the ECC unit.

7. A data storage device comprising:
an error correction code (ECC) unit suitable for processing write data using an ECC;
an error insertion unit suitable for inserting an error in processed data;
a randomization unit suitable for randomizing error-inserted data; and
a control unit suitable for storing randomized data in a nonvolatile memory device.

8. The data storage device according to claim 7, wherein the error insertion unit inverts one or more data bits of the processed data.

9. The data storage device according to claim 8, wherein the error insertion unit inverts the data bits within an error correction capability of the ECC unit.

10. The data storage device according to claim 8, wherein the error insertion unit inverts a data bit at a random position among the data bits of the processed data.

11. The data storage device according to claim 7,
wherein the control unit reads data from the nonvolatile memory device,
wherein the randomization unit derandomizes read data, and
wherein the ECC unit processes derandomized data using the ECC.

12. The data storage device according to claim 11, wherein the ECC unit encodes the write data and decodes the derandomized data using the ECC unit.

13. The data storage device according to claim 11, further comprising:
a memory interface unit suitable for providing a control signal to the nonvolatile memory device and exchanging the write and read data with the nonvolatile memory device, under control of the control unit.

14. The data storage device according to claim 13, wherein the memory interface unit includes the ECC unit, the error insertion unit and the randomization unit.

15. An operating method of a data storage device, comprising:
encoding write data and decoding read data using an error correction code (ECC);
inserting an error in encoded data; and
storing error-inserted data and reading stored data as the read data.

16. The operating method according to claim 15, further comprising:
randomizing the error-inserted data, before the storing of the error-inserted data; and
derandomizing the read data, after the reading of the stored data.
